(19) United States
(12) Patent Application Publication
(10) Pub. No.: US 2016/0042385 A1
(43) Pub. Date: Feb. 11, 2016

(54) ADVERTISEMENT IMPRESSIONS AND CUSTOMER TRANSACTION CORRELATION FOR ADVERTISEMENT VALIDATION INCLUDING INFLUENCERS

(71) Applicant: BANK OF AMERICA CORPORATION, Charlotte, NC (US)

(72) Inventors: Jason P. Blackhurst, Charlotte, NC (US); Frederick A. Shahda, Charlotte, NC (US); Robert L. Abbott, Charlotte, NC (US); Alfred Hamilton, Charlotte, NC (US)

(21) Appl. No.: 14/541,862

(22) Filed: Nov. 14, 2014

Related U.S. Application Data
(60) Provisional application No. 62/035,801, filed on Aug. 11, 2014.

(51) Int. Cl. G06Q 30/02

(52) U.S. Cl. CPC G06Q 30/0242

(57) ABSTRACT

Embodiments of the invention are directed to a system, method, or computer program product for providing feedback and validation of advertising and marketing campaigns and the influence of those advertisements relative to time of the advertisement and payment type demographics. The invention receives advertisement impressions by customers, thus detecting advertisements that the customer has viewed. Furthermore, the invention retrieves transactional data associated with transactions made by the customer. The invention then correlates or matches the advertisement impressions and transactional data to determine if products, services, or merchant transactions that were associated with advertisements viewed by the customer. Furthermore, the invention identifies a payment type used for the transaction. The invention also correlates specific times/dates of advertisements to the transaction. In this way, the invention may provide an advertiser with payment type demographic data and a valuation or influence of advertisements relative to presentation time and location of the advertisements.

### CLAIM OF PRIORITY UNDER 35 U.S.C. §119

The present application for patent claims priority to Provisional Application No. 62/035,801 entitled “Advertisement Impressions and Customer Transaction Correlation for Advertisement Validation” filed Aug. 11, 2014 and Non-Provisional application Ser. No. 14/471,371 entitled “Advertisement Impressions and Customer Transaction Correlation for Advertisement Validation” filed Aug. 28, 2014 both of which assigned to the assignee hereof and hereby expressly incorporated by reference herein.

### BACKGROUND

Advancements in internet technology, social media, and the like allow for a multitude of options for advertisers to advertise products and services. Furthermore, advertisers can reach a broader customer base than ever before. With these additional advertisement outlets, merchants may be able to invest more and more assets into advertising. However, while these advancement allow for a broader customer base to potentially be reached, it becomes difficult to target and track the effectiveness of any one advertisement campaign.

### BRIEF SUMMARY

Embodiments of the present invention address the above needs and/or achieve other advantages by providing apparatuses (e.g., a system, computer program product and/or other devices) and methods to provide customer advertisement impressions and customer transaction correlations for advertisement effectiveness based on influencers. In this way, influencers such as a type of payment type used for a transaction for a product of an advertisement and a time/date of most successful advertisement for a product of an advertisement provides the advertiser with payment type demographics, time/date advertisement influence data, and valuation data for the advertisement. Along with this, the system bridges an important advertising gap between an advertisement and a subsequent brink and mortar store purchase.

In some embodiments, the invention receives information indicating that advertisements were viewed by a customer. An advertiser or merchant may provide information to the system regarding the advertisements that were viewed by a customer, such as a customer identification, merchant, time period, geographic location, transaction channel, or the like associated with the advertisement.

In some embodiments, the advertisement viewed by the customer may be online. In other embodiments, the advertisement viewed by the customer may be in printed version, such as in a newspaper, magazine, billboard, or the like. For online advertisements, customer views of the website or advertisements that the customer is predicted to have viewed via a website are identified. In this way, the customer may be on one or more webpages on the internet. The customer may be presented with multiple advertisements, such as offers, deals, promotions, incentives, or the like while accessing the internet. The system may receive an indication that the customer viewed or potentially viewed the advertisements. As such, the system may retrieve, and/or receive customer advertisement impressions, which are advertisements that a customer viewed. The viewed advertisements may be identified by the customer selecting or clicking an advertisement, by scrolling over the advertisement, a duration of viewing the advertisement, customer searches and search results, social network endorsements, or the like.

For offline advertisements, one or more advertisements may be viewed or predicted to have been viewed by the customer offline. These advertisements may include billboards, magazines, newspapers, flyers, television, or the like. The customer may be presented with multiple advertisements, such as offers, deals, promotions, incentives, or the like while offline. The system may receive information associated with the advertisements viewed or potentially viewed by the customer. As such, the system receives and/or identifies customer advertisement impressions or advertisements viewed by the customer. The viewed advertisements may be identified by customer newspaper or magazine subscriptions, global positioning systems (GPS), travel routes, travel or transportation location purchases, television guides, or the like.

Once the advertisements that were viewed by the customer are identified, the invention may receive information associated with the one or more products, services, offers, promotions, or the like associated with the advertisement. In some embodiments, once the system receives the advertisements viewed by the customer, the merchant, product, service, offer, promotion, or the like associated with the advertisement is identified. In some embodiments, this information may be received from the advertiser or merchant. In other embodiments, the system may retrieve the information about the merchant or product based on knowledge of advertisement viewed by the customer, advertisement positioning, object recognition, or the like.

Once the product of the advertisement and the customer is identified, the system may monitor the customer's financial transactions. In this way, the system may identify purchases for products, services, or the like associated with the viewed advertisements. In some embodiments, the system may receive customer transaction data associated with customer transactions for the products, services, or the like associated with the viewed advertisements. The transaction data may identify one or more financial transactions of the customer that are for or associated with the products, merchants, or services of the advertisements. The transaction data may be identified based on financial institution data, merchant data, social media data, or customer provided data. The system may be provided with the transaction data from a financial institution. In other embodiments, the system may determine the transaction data based on the system being implemented by a financial institution. In some embodiments, the system may determine transaction data by receiving or retrieving information from the merchant, social networks, and/or the customer.

In some embodiments, the system correlates or matches the products, merchants and/or services of the advertisement with subsequent transactions of the customer. As such, the monitoring of customer transaction data leads the system to identifying a match between a product of the advertisement and a subsequent purchase by the customer.

In this way, the system receives information regarding the advertisements that were viewed by a customer. This information including, a customer identification, merchant, time of viewing, duration of viewing, geographic location, channel of viewing, or the like associated with the advertisement. Then, the system may identify one or more products or services of that advertisement viewed by the customer that were subsequently purchased by the customer. In this way, indicating a positive advertisement or marketing campaign. In this way, the system may determine an advertisement interest in a category of a product, a product, or the like.

In some embodiments, feedback is provided to an advertiser based on the match. The feedback may include an amount of customers that viewed the advertisement compared to an amount of customers that purchased the products associated with that advertisement. Furthermore, the system may identify influencers that may contribute to the success of the advertisement. In some embodiments, the indicators may identify a payment type demographic. Thus providing an indication of a customer that is more likely to purchase the products of the advertisement, thus providing information to an advertiser regarding specific targeting of customers based on payment type demographics identified by the system. In some embodiments, the indicators may provide advertisers with a valuation of time/date or channel of advertisement having success based on the time, date, and/or location that the advertisement for a product is viewed. For example, an ice cream advertisement may have stronger influence and more value if it was ran on a television channel during a summer day as opposed to a winter night.

In some embodiments, the indicators may identify a payment type demographic of customers that purchased a product of the advertisement. In this way, the system may identify one or more payment types used by a customer to purchase the products of the advertisement. The payment types, such as a debit card, credit card, cash, check, or the like may be utilized to determine a payment type demographic associated with the purchase of a product of an advertisement. This way, the system may provide payment type demographics data to the advertiser such that the advertiser may have an indication as to a demographic for targeting future advertisements.

In some embodiments, the indicators may provide advertisers with a valuation of time and date of an advertisement and the success of that advertisement based on that time and/or date. As such, insight into time and date of advertisement and the effectiveness of an advertisement at a specific time and date drives value of the advertisement based on a time and date of the advertisement and a channel presenting the advertisement. In this way, an advertisement space provider may identify prime times or channels for advertisements for specific products, thus increasing an assessment associated with an advertisement to be presented at that particular time, date, and channel. Furthermore, the merchant may be provided with information and feedback regarding the times of day and dates of year that the merchant's advertisements are most effective.

Finally, the system may provide the advertiser, merchant, or the like with feedback for the advertisements. Not only will the system provide information regarding which advertisements may be positive resulting and which are not, such that the merchant may determine the most positive advertisement campaign based on this data. The system may also provide feedback based on influencers, such as a type of payment type used for a transaction for a product of an advertisement and a time/date/location indication of the transaction for a product of an advertisement relative to the time/date/location of the advertisement and provide the advertiser with influence data and valuation data for the advertisement, such as payment type demographics and time/date/location advertisement valuation.

In some embodiments, the system generates and provides marketing effectiveness data based on the established correlations. As such, the invention generates marketing effectiveness data that tracks the advertisements and the effectiveness of the advertisements based on purchases associated with advertisement impressions.

Embodiments of the invention relate to systems, methods, and computer program products for advertisement validation, the invention comprising: receiving information indicating one or more advertisements for a merchant, product, and/or service viewed by a customer, wherein the information indicating one or more advertisements includes a time and date the advertisement was viewed by the customer; receiving transaction data associated with transactions completed by the customer, wherein transaction data includes a payment type used to complete the transactions; matching the merchant, product, and/or service of the one or more advertisements viewed by the customer to transactions completed by the customer; determining payment demographics for the merchant, product, and/or service, wherein the payment demographics identify the payment types used for the transaction; determining a time influence of the advertisement, wherein the time influence of the advertisement is based on identifying the time and date of the advertisement for the merchants, product, and/or services that matched the transactions completed by the customer; and providing advertising effectiveness data including the payment demographics and time influence data to an advertiser.

In some embodiments, determining payment demographics for the merchant, product, and/or service further comprises compiling the payment types used for the transactions and calculating a percentage use of each payment type for the transactions, wherein payment types include a debit account, credit account, cash, or check.

In some embodiments, determining the time influence of the advertisement further comprises grouping transactions together based on a specific time range of when the viewed advertisement for the merchants, product, and/or service of the transaction, wherein the groupings are compared to determine the effectiveness of the advertisement based on the time the advertisement was viewed, wherein a most effective time of the advertisement correlates to the most transactions grouped together in the specific time range.

In some embodiments, receiving information indicating one or more advertisements for a merchant, product, and/or service viewed by a customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer. In some embodiments, receiving information indicating one or more advertisements for a merchant, product, and/or service viewed by a customer further comprises receiving information indicating a date and a time of the customer viewing of the at least one advertisement.

In some embodiments, matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

In some embodiments, providing advertising effectiveness data including the payment demographics and the time influence data further comprises providing a confidence associated with a success of the at least one advertisement based on a likelihood that the at least one advertisement was viewed by the customer, a perfect or imperfect match of products of the at least one advertisement and the transaction, and a time frame between the at least one advertisement for the product and the transaction for the product in a viewed advertisement.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating advertisement impressions and customer transaction correlation process, in accordance with one embodiment of the present invention;

FIG. 2 provides a process flow illustrating identifying payment type demographics for advertisement impressions, in accordance with one embodiment of the present invention;

FIG. 3 provides a process flow illustrating timing influencers for advertisement impressions, in accordance with one embodiment of the present invention;

FIG. 4 provides an advertisement impression and customer transaction correlation system environment, in accordance with one embodiment of the present invention;

FIG. 5 provides a process map illustrating an advertisement impressions and customer transaction correlation process, in accordance with one embodiment of the present invention;

FIG. 6 provides a process map illustrating advertisement impression identification, in accordance with one embodiment of the present invention;

FIG. 7 provides a process map illustrating transaction data retrieval and matching, in accordance with one embodiment of the present invention; and

FIG. 8 provides a process map illustrating creating and providing marketing effectiveness tracking data, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

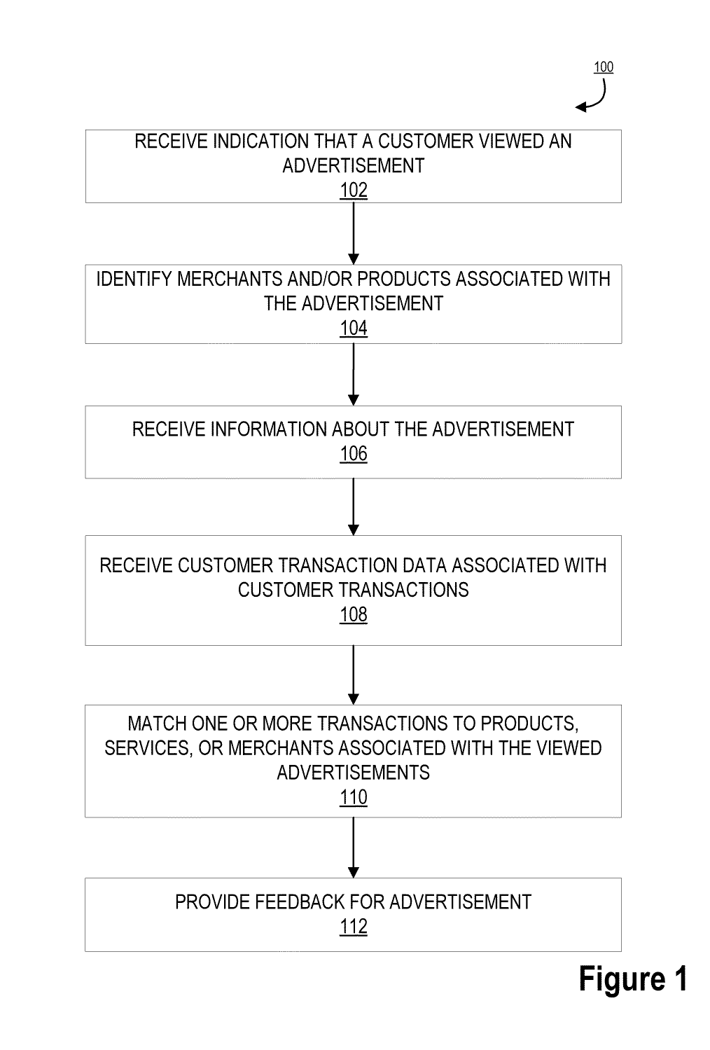

FIG. 1 provides high level process flow illustrating advertisement impressions and customer transaction correlation process 100, in accordance with one embodiment of the present invention. As illustrated in block 102, the system may receive an indication that a customer viewed an advertisement, which may include an advertisement, deal, offer, coupon, promotion, incentive, or the like. In some embodiments, the advertisement may be online. In other embodiments, the advertisement may be offline. The indication may be received from an advertiser, customer, merchant, or the like. Alternatively, in some embodiments, the system may identify customer viewed advertisements.

As illustrated in block 104, the process 100 continues by identifying the merchants, products, and/or services associated with the advertisement that was viewed by the customer. In this way, the system may receive from an advertiser or merchant information about a product or merchant of the advertisement. Next, as illustrated in block 106, the process 100 receives information about the advertisement. In this way, the system may receive from a merchant or advertiser information about the merchant of the advertisement, the product of the advertisement, the time period of the advertisement, the geographic location of the advertisement, the channel of providing the advertisement, and the like.

With an indication that customers viewed the advertisement and information about the advertisement, the process 100 receives subsequent customer financial transactions for transactions associated with merchants, products, and/or services of the advertisements, as illustrated in block 108.

As illustrated in block 110, the process 100 matches one or more transactions of the customer with one or more advertisements viewed by the customer. The match may be based on matching a merchant, product, and/or service purchased by the customer, as identified from customer transactions, with one or more advertisements that the customer viewed. As illustrated in block 112 the process 100 creates feedback in the form of marketing effectiveness data to one or more advertisers. The feedback provides customer advertisement impressions and customer transaction correlations for advertisement effectiveness based on influencers. In this way, influencers such as a type of payment type used for a transaction for a product of an advertisement and a time/date/location indication of the transaction for a product of an advertisement relative to the time/date/location of the advertisement provides the advertiser with payment type demographics, influence data, and valuation data for the advertisement.

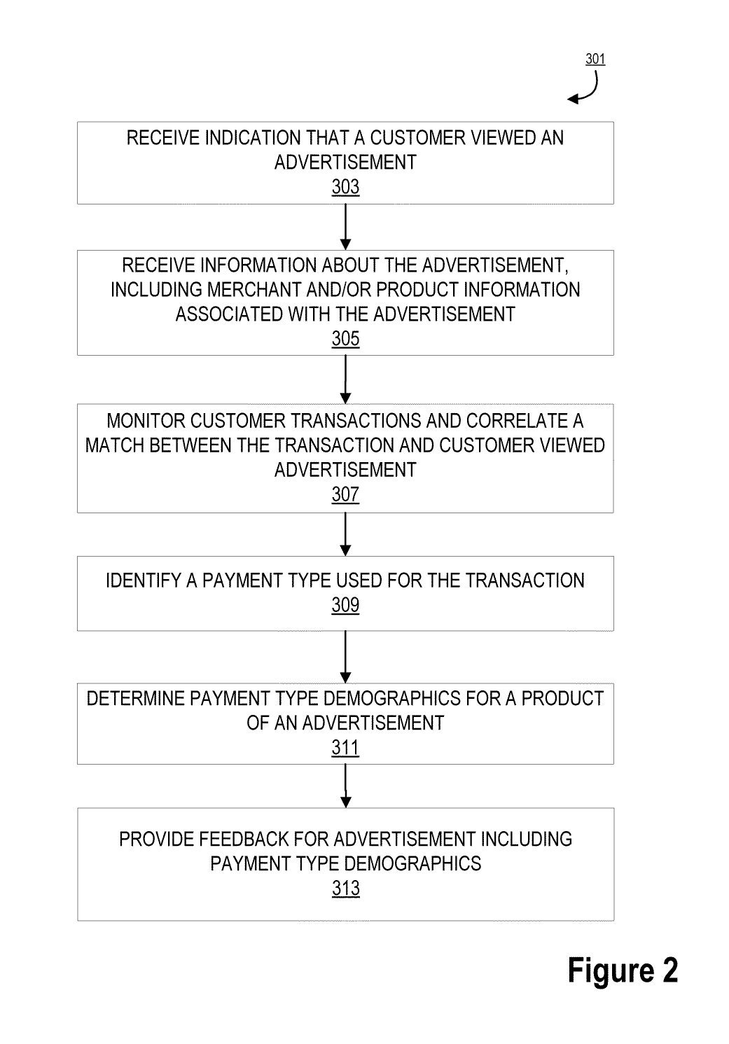

FIG. 2 provides a process flow illustrating identifying payment type demographics for advertisement impressions 301, in accordance with one embodiment of the present invention. As illustrated in block 303, the process 301 is initiated when the system receives an indication that one or more customers viewed an advertisement. In this way, the system may receive, from a merchant, advertiser, or the like, an indication that customers viewed an advertisement.

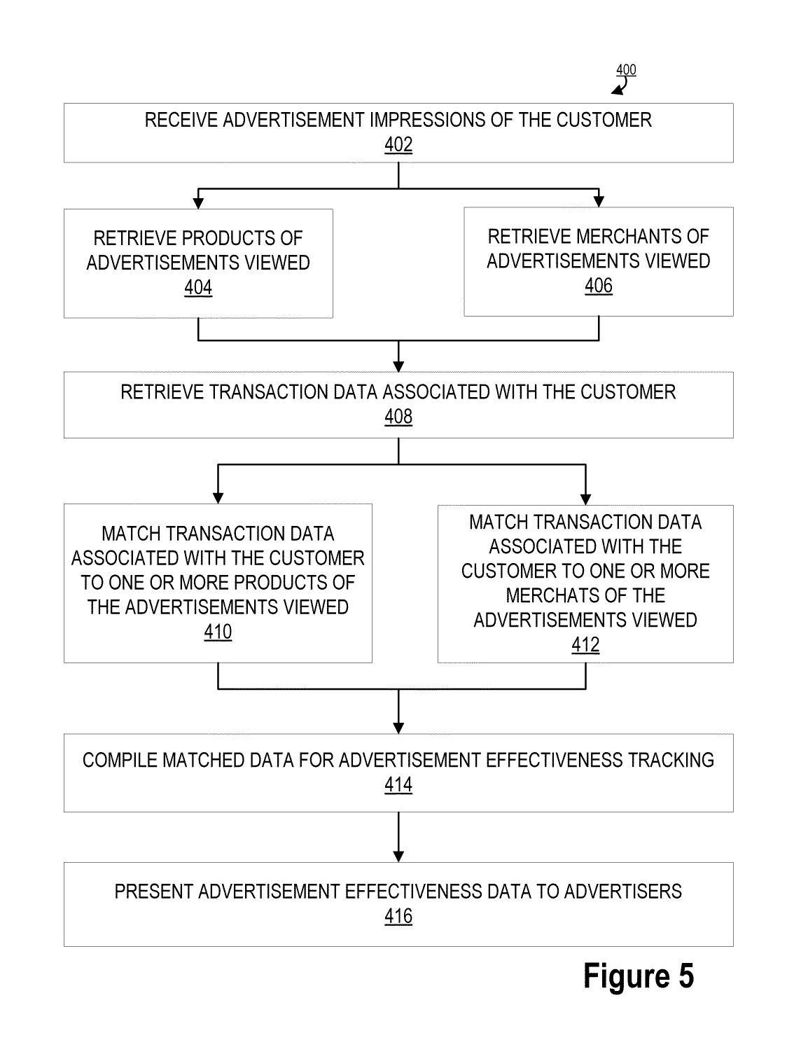

As illustrated in further detail below with respect to FIG. 5, multiple ways are utilized to identify advertisements viewed by a customer. In some embodiments, the advertisements may be online. In other embodiments, the advertisements may be offline. For online advertisements, the system may determine that a customer has viewed the advertisement based on advertisement impression identification factors such as customer selecting or clicking on the advertisement, the customer scrolling over the advertisement, the duration the customer is viewing the webpage with the advertisement, searches associated with the customer, the IP address of the customer, and/or social network endorsements. For offline advertisements, the system may determine that a customer has viewed the advertisement based on identification factors such as a subscription to newspapers, flyers, magazines, and the like, television guides, global positioning systems, and/or travel purchases.

Next, as illustrated in block 305, the process continues by receiving information about the advertisement, which includes information about the merchant and/or product information associated with that advertisement. In this way, the system may receive information about the merchant providing the product or advertisement. Furthermore, the system may receive information about the product of the advertisement, such as a type, brand, price, or the like. Finally, included in the received information is information about the advertisement itself. This information may include a channel that the advertisement is presented on, such as online, offline, and specific type of channel, such as a magazine, newspaper, website, email, or the like. This information may also include a time and date the advertisement was presented, a time and date range of advertisement presentment, a time and date that the advertisement was viewed by the customer, and the like.

As illustrated in block 307, the process 301 continues by monitoring customer transactions and correlating a match between the transaction and customer viewed advertisements. In this way, the system retrieves transaction data associated with the customers. In some embodiments, the system may receive the customer's transaction activity after an advertisement viewed by the customer has been identified. The retrieval may identify one or more financial transactions of the customer that are for or associated with the products or merchants of the advertisements viewed by the customer. The system may retrieve the transaction data based on financial institution data, merchant data, social media data, or customer provided data. The system may be provided by a financial institution, as such, the system may be able to determine if purchases are associated with products of the advertisements based on financial institution data associated with the transaction. In some embodiments, the system may determine transaction data by receiving information from the merchant, social networks, and/or the customer. Once the customer transaction data has been retrieved, the system may match transaction data associated with the customer to one or more products of the advertisements viewed by that customer.

In some embodiments, matching the transaction data to one or more products, one or more merchants, and/or one or more services of the advertisements viewed by the customer comprises determining a time and date of a transaction completed by the customer and matching it with an advertisement viewed by the customer if the time and date of the transaction is within a selected range of time after the customer viewed the advertisement.

Next, as illustrated in block 309, the process 301 continues by identifying a payment type used for the transaction where the transaction is for a product or merchant of the advertisement viewed by the customer. As such, the system may identify the payment type used for a transaction. A payment type may include a credit card, debit card, cash, gift card, or the like. In this way, the system may identify the payment type and an account associated with the payment type. The system may be associated with the financial institution to access and obtain payment type information. In other embodiments, the system may be in communication with a financial institution in order to retrieve the payment type. The payment type may be identified in a generic fashion, such that simply a payment type, such as “debit card” or “credit card” may be identified in block 309.

Next, as illustrated in block 311, the system may determine payment type demographics for a product of an advertisement. In this way, the system may compile data associated with all customers that viewed the advertisement and subsequently purchased the product associated with that advertisement viewed. The system may compile the payment type used and determine payment type demographics for the advertisement. In this way, the system may be able to calculate a percentage of each payment type used for the product. In some embodiments the system may determine the most used payment type, the least used payment type, an average, or the like. The system may use the payment type information to determine payment type demographics for the product of the transaction. In this way, the demographics of customers purchasing the product may be identified based on payment type utilized.

Finally, as illustrated in block 313, the process 301 ends by providing feedback for the advertisement which includes the determined payment type demographics. The payment type demographics may provide the most used payment type by customers purchasing the product of the advertisement, a percentage of each payment type used, or the like. This payment type demographics, along with providing feedback in the way of advertisement effectiveness data associated with advertisements may be provide to the merchant or advertiser. As such, the system may also generates and provides marketing effectiveness data based on the correlation between the advertisement being viewed by the customer and a transaction for the products associated with the advertisement along with the payment type demographic data. As such, the invention generates marketing effectiveness data that tracks the advertisements and the effectiveness of the advertisements based on purchases associated with advertisement impressions.

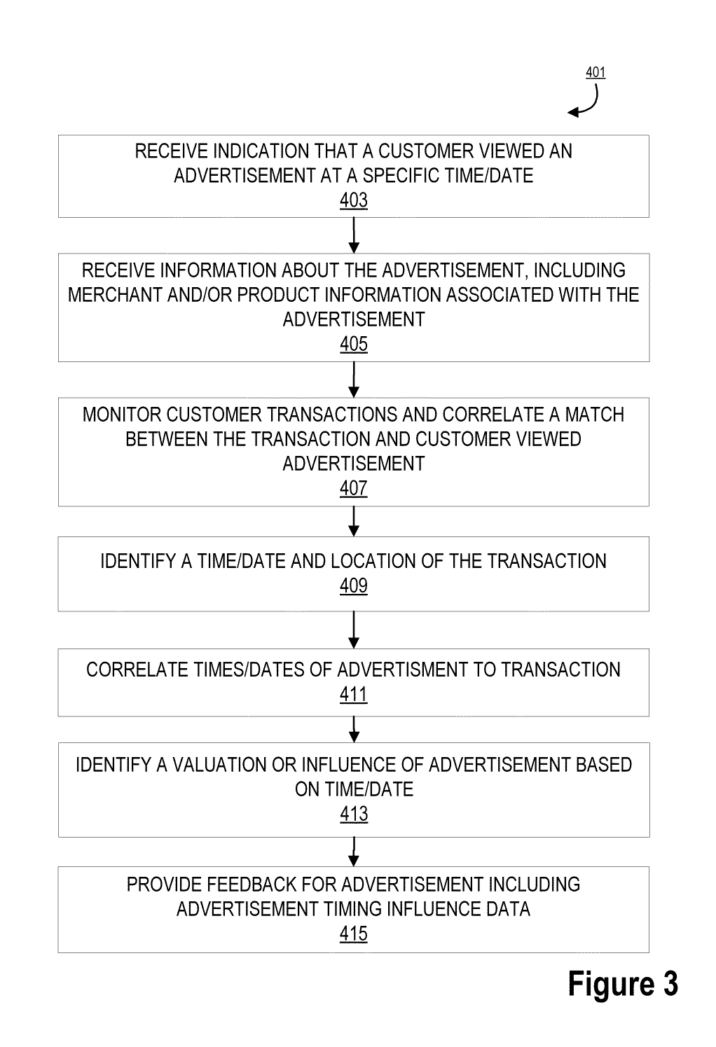

FIG. 3 provides a process flow illustrating timing influencers for advertisement impressions 401, in accordance with one embodiment of the present invention. As illustrated in block 403, the process 401 is initiated when the system receives an indication that one or more customers viewed an advertisement at a specific time and/or date. In this way, the system may receive, from a merchant, advertiser, or the like, an indication that customers viewed an advertisement. Associated with this information may include a time and/or date that the customer viewed the advertisement, a time frame or multiple times that a customer viewed the advertisement, and the like.

As illustrated in further detail below with respect to FIG. 5, multiple ways are utilized to identify advertisements viewed by a customer. In some embodiments, the advertisements may be online. In other embodiments, the advertisements may be offline. For online advertisements, the system may determine that a customer has viewed the advertisement based on advertisement impression identification factors such as customer selecting or clicking on the advertisement, the customer scrolling over the advertisement, the duration the customer is viewing the webpage with the advertisement, searches associated with the customer, the IP address of the customer, and/or social network endorsements. For offline advertisements, the system may determine that a customer has viewed the advertisement based on identification factors such as a subscription to newspapers, flyers, magazines, and the like, television guides, global positioning systems, and/or travel purchases.

Next, as illustrated in block 405, the process continues by receiving information about the advertisement, which includes information about the merchant and/or product information associated with that advertisement. In this way, the system may receive information about the merchant providing the product or advertisement. Furthermore, the system may receive information about the product of the advertisement, such as a type, brand, price, or the like. Finally, included in the received information is information about the advertisement itself. This information may include a channel that the advertisement is presented on, such as online, offline, and specific type of channel, such as a magazine, newspaper, website, email, or the like. This information may also include a time and date the advertisement was presented, a time and date range of advertisement presentment, and the like.

As illustrated in block 407, the process 401 continues by monitoring customer transactions and correlating a match between the transaction and customer viewed advertisements. In this way, the system retrieves transaction data associated with the customers. In some embodiments, the system may receive the customer's transaction activity after an advertisement viewed by the customer has been identified. The retrieval may identify one or more financial transactions of the customer that are for or associated with the products or merchants of the advertisements viewed by the customer. The system may retrieve the transaction data based on financial institution data, merchant data, social media data, or customer provided data. The system may be provided by a financial institution, as such, the system may be able to determine if purchases are associated with products of the advertisements based on financial institution data associated with the transaction. In some embodiments, the system may determine transaction data by receiving information from the merchant, social networks, and/or the customer. Once the customer transaction data has been retrieved, the system may match transaction data associated with the customer to one or more products of the advertisements viewed by that customer.

Next, as illustrated in block 409, the system may identify a time and date for the transaction. The time and date of the transaction may be determined by the system, may be provided by a financial institution managing the account used during the transaction, or may be provided by the merchant. As illustrated in block 411, the process 401 continues by correlating the times and dates of the advertisement to the transaction. In some embodiments, the correlation involved calculating a time frame between the viewing of the advertisement relative to the transaction. In this way, a time frame between the advertisement and the purchase may be calculated to determine a relative influence of the advertisement.

In some embodiments, as illustrated in block 413, a valuation or influence of the advertisement maybe identified based on the time and date. As such, the correlation of time and date of advertisements to transactions may aid determining the successfulness of an advertisement based on the time and date the advertisement was presented to the customer. In this way, transactions for products associated with viewed advertisements are grouped relative to the time and date the advertisement was viewed. For example, there may be identified 100 customers that purchased a product associated with an advertisement. Of those 100, 20 may have viewed the advertisement on Day A between 8:00 am and 10:00 am and 80 may have viewed the advertisement on Day A between 6:00 pm and 10:00 pm. In this way, for each product purchases, a time and date of advertisement viewed may be correlated to that purchase. The total number of customers purchasing that product may then be matched to a time and date or general time and date range of when each of the customers viewed the advertisement associated with that product. As such, the time and date data may be utilized to identify the most effective times to advertise for that particular product. As such, an influence or valuation of the advertisement time may be determined for that particular product. As a further example of this valuation is an ice cream advertisement may have stronger influence and more value if it was ran on a television channel during a summer day as opposed to a winter night.

Finally, as illustrated in block 415, the process 401 ends by providing feedback for the advertisement which includes advertisement timing influence data. The timing influence data may provide the most successful times of the advertisement for a particular product. In this way, allowing an advertiser to quantify the prime advertisement locations associated with a product or category of products. This timing influence data, along with providing feedback in the way of advertisement effectiveness data associated with advertisements may be provide to the merchant or advertiser. As such, the system may also generates and provides marketing effectiveness data based on the correlation between the advertisement being viewed by the customer and a transaction for the products associated with the advertisement along with the timing influence data. As such, the invention generates marketing effectiveness data that tracks the advertisements and the effectiveness of the advertisements based on purchases associated with advertisement impressions. Furthermore, the system may identify specific transactions that happened throughout the day for a customer. In this way, the system may identify timing for a day/week or shopping experience for a customer, thus identifying timing of customer transactions for that time period based on one or more advertisements viewed by the customer.

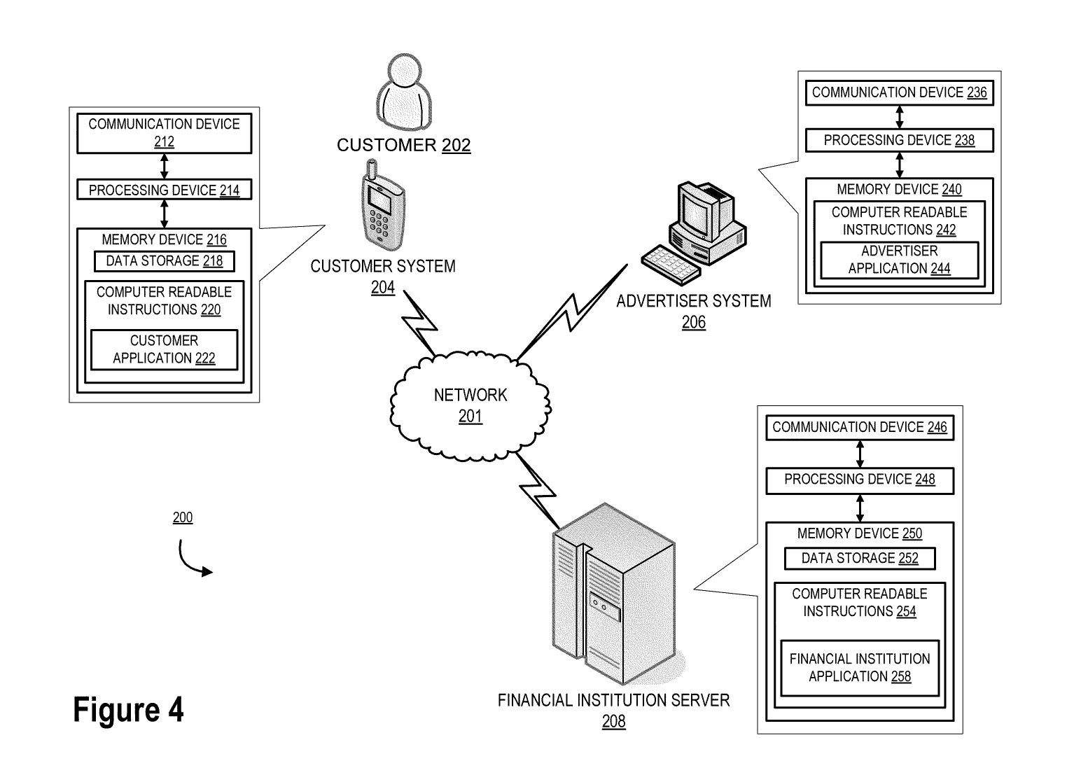

FIG. 4 illustrates an advertisement impression and customer transaction correlation system environment 200, in accordance with one embodiment of the present invention. As illustrated in FIG. 4, the financial institution server 208 is operatively coupled, via a network 201 to the customer system 204, and to the advertiser system 206. In this way, the financial institution server 208 can send information to and receive information from the customer system 204 and the advertiser system 206 to provide advertisement impressions and customer transaction correlation for advertisement effectiveness tracking FIG. 4 illustrates only one example of an embodiment of an advertisement impression and customer transaction correlation system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual viewing an advertisement online or offline. The customer 202 may subsequently make one or more transactions to purchase a product. In some embodiments, the purchase may be made by the customer 202 using a customer system 204. In some embodiments, the customer 202 may be a merchant or a person, employee, agent, associate, independent contractor, and the like that has an account or business with a financial institution or another financial institution that may provide payment to complete a transaction.

FIG. 4 also illustrates a customer system 204. The customer system 204 generally comprises a communication device 212, a processing device 214, and a memory device 216. The customer system 204 is a computing system that allows a customer 202 to interact with the financial institution to set up payment or transaction accounts to complete transactions for products and/or services. The processing device 214 is operatively coupled to the communication device 212 and the memory device 216. The processing device 214 uses the communication device 212 to communicate with the network 201 and other devices on the network 201, such as, but not limited to the advertiser system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may open a financial institution account, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 4, system environment 200 may contain numerous customer systems 204.

As further illustrated in FIG. 4, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the advertiser system 206 and the customer system 204. As such, the communication device 246 generally comprises a modem, server, or other device for communicating with other devices on the network 201.

As further illustrated in FIG. 4, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to advertisement impressions and customer transaction correlation, but not limited to data created and/or used by the financial institution application 258.

In the embodiment illustrated in FIG. 4 and described throughout much of this specification, the financial institution application 258 may receive an indication that a customer 202 viewed an advertisement, receiving information about the merchants and products associated with the advertisement, receive customer 202 transactions for transactions associated with products or merchants of the advertisement viewed, match the transactions to products or merchants associated with the advertisements, and compile advertisement effectiveness data to advertisers, which may include payment demographic data and/or time and date advertisement influence data.

In some embodiments, in conjunction with the advertiser system 206, the financial institution application 258 may receive an indication that a customer 202 viewed an advertisement. Furthermore this indication of customer viewing may also include a time and date that the customer 202 viewed the advertisement. In some embodiments, multiple dates and times may be identified if the customer 202 has viewed the advertisement at multiple times. In yet other embodiments, a duration or time frame may be identified if the customer 202 has been identified as viewing the advertisement for any duration of time. In some embodiments, the advertisement may be online. In other embodiments, the advertisement may be offline. For online advertisements, the financial institution application 258 may identify advertisement impressions when a customer 202 views or is predicted to have viewed the advertisement via the internet. In this way, the customer 202 may be on one or more webpages on the internet. The customer 202 may be presented with multiple advertisements, such as offers, deals, promotions, incentives, or the like while accessing the internet. The financial institution application 258 may identify the advertisements viewed or potentially viewed by the customer 202. The viewed advertisements may be identified by the financial institution application 258 based on an identification of factors, including, but not limited customer 202 selecting or clicking an advertisement, customer 202 scrolling over the advertisement, a determined duration the customer 202 viewed the advertisement, customer 202 searches and search results, social network endorsements of the customer 202, or the like.

In some embodiments, in conjunction with the advertiser system 206, the financial institution application 258 may receive information about the merchants and products associated with the viewed advertisements. The merchant or product may be identified based on knowledge of advertisement positioning from communications with the advertiser system 206 via the network 201, object recognition, or the like. In some embodiments, the customer 202 that is viewing the advertisement may also be identified and that information may be received by the financial institution application 258. The customer 202 may be identified based on internet protocol address, log-in information for the customer 202, global positioning systems, mobile communication links, wireless networks, or the like.

In some embodiments, the financial institution application 258 may receive customer transaction data associated with customer 202 transactions. The financial institution application 258 may identify customer 202 transactions for specific transactions associated with products or merchants of the advertisement viewed by the customer 202. Furthermore, the customer transaction data may include a payment type used for the transaction and a time stamp for the transaction. The payment type may be a credit card, debit card, cash, gift card, check, or the like.

In some embodiments, the financial institution application 258 may find and match at least one monitored transactions to products or merchants associated with the advertisements viewed. In this way, matching the merchant, product, and/or service of the one or more advertisements viewed by the customer 202 to transactions completed by the customer 202 comprises identifying a date and/or a date and time of a transaction completed by the customer 202 and matching it with an advertisement viewed by the customer 202, if the date and/or date and time of the transaction is after the date and time when the customer 202 viewed the advertisement.

In some embodiments, matching the merchant, product, and/or service of the one or more advertisements viewed by the customer 202 to transactions completed by the customer comprises identifying perfect matches and imperfect matches, wherein perfect matches are a same merchant, product, and/or service associated with a transaction of the customer 202 and the at least one advertisement viewed by the customer 202 and imperfect matches are a similar merchant, product, and/or service of a customer transaction and the at least one advertisement viewed by the customer 202.

Finally, the financial institution application 258 may compile advertisement effectiveness data and provide it to the advertisers via the advertiser system 206 for marketing analysis and effectiveness tracking. In some embodiments, the advertisement effectiveness data may include payment type demographic data. In other embodiments, the advertisement effectiveness data may include time/date advertisement influence data.

In some embodiments, the financial institution application 258 may compile advertisement effectiveness data that includes payment demographic data. The financial institution application 258 may retrieve or identify a payment type used for the transaction where the transaction is for a product or merchant of the advertisement viewed by the customer 202. As such, the financial institution application 258 may identify the payment type used for a transaction. A payment type may include a credit card, debit card, cash, gift card, or the like. In this way, the financial institution application 258 may identify the payment type and an account associated with the payment type. The payment type may be identified in a generic fashion, such that simply a payment type, such as “debit card” or “credit card” may be identified.

The financial institution application 258 may determine payment type demographics for a product of an advertisement. In this way, the financial institution application 258 may compile data associated with all customers that viewed the advertisement and subsequently purchased the product associated with that advertisement viewed. The financial institution application 258 may compile the payment type used and determine payment type demographics for the advertisement. In this way, the financial institution application 258 may be able to calculate a percentage of each payment type used for the product. In some embodiments the financial institution application 258 may determine the most used payment type, the least used payment type, an average, or the like. The financial institution application 258 may use the payment type information to determine payment type demographics for the product of the transaction. In this way, the demographics of customers purchasing the product may be identified based on payment type utilized.

In some embodiments, the financial institution application 258 may compile advertisement effectiveness data that includes time/date advertisement influence data. In this way, the financial institution application 258 may identify a time and date for the transaction. The time and date of the transaction may be determined by the financial institution application 258, may be provided by a financial institution managing the account used during the transaction, or may be provided by the merchant. Subsequently, the financial institution application 258 may correlate the times and dates of the advertisement to the transaction. In some embodiments, the correlation involved calculating a time frame between the viewing of the advertisement relative to the transaction. In this way, a time frame between the advertisement and the purchase may be calculated to determine a relative influence of the advertisement. The financial institution application 258 may determine a valuation or influence of the advertisement maybe identified based on the time and date. As such, the correlation of time and date of advertisements to transactions may aid determining the successfulness of an advertisement based on the time and date the advertisement was presented to the customer 202. In this way, transactions for products associated with viewed advertisements are grouped relative to the time and date the advertisement was viewed by the financial institution application 258. In this way, for each product purchases, a time and date of advertisement viewed may be correlated to that purchase. The total number of customers purchasing that product may then be matched to a time and date or general time and date range of when each of the customers viewed the advertisement associated with that product. As such, the time and date data may be utilized by the financial institution application 258 to identify the most effective times to advertise for that particular product. As such, an influence or valuation of the advertisement time may be determined for that particular product.

As such, the financial institution application 258 may provide effectiveness data to the advertisers via the advertiser system 206 for marketing analysis and effectiveness tracking which includes payment type demographic data and/or time/date advertisement influence data.

As illustrated in FIG. 4, the advertiser system 206 is connected to the financial institution server 208 and is associated with the entity providing the advertisements. In this way, while only one advertiser system 206 is illustrated in FIG. 4, it is understood that multiple advertiser systems may make up the system environment 200. The advertiser system 206 generally comprises a communication device 236, a processing device 238, and a memory device 240. The advertiser system 206 comprises computer-readable instructions 242 stored in the memory device 240, which in one embodiment includes the computer-readable instructions 242 of an advertiser application 244.

In the embodiment illustrated in FIG. 4, the advertiser application 244 provides advertisements to customers 202, identifies customers 202 that viewed the advertisement, identifies merchants and products of the advertisements, and receives marketing effectiveness data.

In some embodiments, the advertiser application 244 may provide the advertisements to the customers 202. The advertiser application 244 may present advertisements via online means or offline means based on the targeted audience the advertiser wishes to target. In some embodiments, the advertiser application 244 may operate in conjunction with the financial institution application 258 to determine that a customer 202 viewed an advertisement and the identification of the customer 202 who viewed the advertisement. In this way, the advertiser application 244 may have data associated with subscriptions provided to customers 202, locations of advertisements, and the like that aid the system determining if a customer 202 viewed an advertisement and/or the identification of the customer 202 viewing the advertisement.

In some embodiments, the advertiser application 244, in conjunction with the financial institution application 258, may identify merchants and products of the advertisements. In this way, the advertiser application 244 is associated with the advertiser. In this way, the advertiser application 244 may have information associated with the products of the advertisement and/or the merchants associated with the advertisement. In some embodiments, the advertiser application 244 may be associated with the merchant of the advertisement.

In some embodiments, the advertiser application 244 may receive marketing effectiveness data from the financial institution server 208 based on the results of the advertisement impressions and customer 202 transaction correlation.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 5 illustrates a process map for an advertisement impressions and customer transaction correlation process 400, in accordance with one embodiment of the present invention. The process 400 is initiated by receiving advertisement impressions of the customer, as illustrated in block 402. Advertisement impressions, as used herein refer to one or more times the customer viewed the advertisement. As such, the system may retrieve information that an advertisement was viewed, but also data about the time and date the advertisement was viewed, the channel of viewing, the duration of viewing the advertisement, and/or the number of times a customer viewed the advertisement.

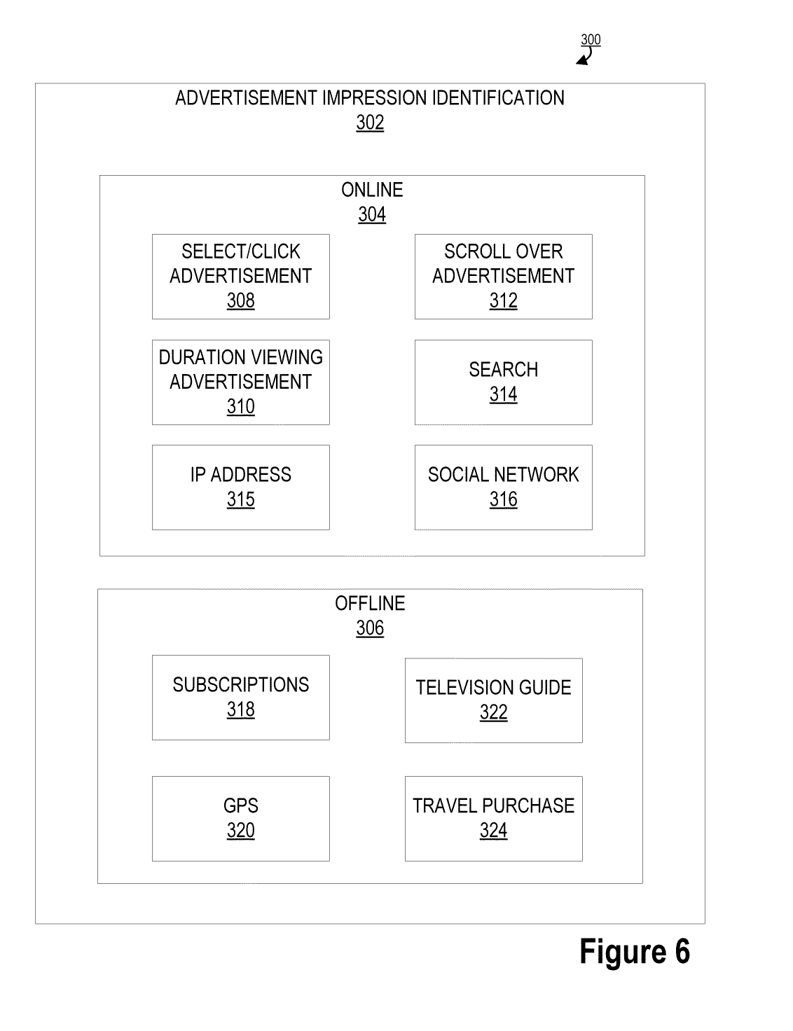

FIG. 6 illustrates a process map for advertisement impression identification 300, in accordance with one embodiment of the present invention. Multiple ways are utilized to identify advertisement impressions or advertisements viewed by a customer 302. In some embodiments, the advertisements may be online, as illustrated in block 304. In other embodiments, the advertisements may be offline, as illustrated in block 306. For online advertisements 304, the system may determine that a customer has viewed the advertisement based on advertisement impression identification factors such as customer selecting or clicking on the advertisement 308, the customer scrolling over the advertisement 312, the duration the customer is viewing the webpage with the advertisement 310, searches associated with the customer 314, the IP address of the customer 315, and/or social network endorsements 316.

In some embodiments, a customer may select or click on the advertisement 308. In this way, the customer may select the advertisement to get more information about the product or merchant associated with the advertisement, print the advertisement, or the like. In this way, there is a high probability that an advertisement impression arose from the customer selecting the advertisement, thus the advertisement is identified as a customer advertisement impression. In some embodiments, the customer may spend a long period of time viewing the advertisement 310. The amount of time the customer is viewing an advertisement may be recognized when a customer is viewing the webpage and/or the advertisement on the webpage. If a customer is identified as viewing a webpage for a duration of time, a determination of the one or more advertisements on that page is made. The duration of time may vary depending on the page. However, if the duration of the customer's time on the webpage is longer, that is an indication that the customer has viewed the advertisements on that webpage. In this way there is a high probability that an advertisement impression arose during the time the customer was on the webpage. In some embodiments, the customer may scroll over the advertisement 312. The scrolling may occur with a curser, icon, finger, touch, eye recognition, or the like. In this way, it may be recognized that the customer is scrolling across or stopping on the advertisement on a webpage. This scrolling may be an indication that the customer has viewed the advertisement on the webpage. As such, there may be a higher probability that an advertisement impression arose during the scrolling period. In some embodiments, the customer may input search criteria into a webpage, search engine, or the like 314. In some embodiments, a customer may search for an advertisement, merchant, or product. The searching may lead to one or more advertisements being presented to the customer based on his/her search. As such, the advertisement may be viewed by the customer. The search may indicate an advertisement impression arose during the searching or results of the search. Next, in some embodiments, advertisement impressions may be identified by social network indicators 316. In this way, a customer may be presented with advertisements on his/her social network. The customer may also endorse advertisement via his/her social network. When a customer is presented with an advertisement on his/her social network or endorses an advertisement on a social network a customer advertisement impression may have been created. Finally, an advertisement impression may be created based on indications from the customer's online activity based on his/her IP address 315. In this way, the system may track previously selected, viewed, or presented advertisement that may indication a customer advertisement impression.

In some embodiments, the advertisements viewed may be offline, as illustrated in block 306. Offline advertisement impression identification factors may include subscriptions 318 to newspapers, flyers, magazines, and the like, television guides 322, global positioning systems 320, and/or travel purchases 324.

In some embodiments, the customer may view advertisements based on a subscription 318 to a newspaper, magazine, flyers, brochures, or the like. In this way, one or more subscriptions associated with the customer may be identified. Furthermore, it may be determined that he/she may review the contents of the subscription based on the subscription. As such, any advertisements that may be contained in the subscribed article may be viewed by the customer, thus may be included in an advertisement impression for that customer. In some embodiments, the customer may view billboards and the like associated with traveling. In this way, the system may utilize GPS 320 and/or travel purchases 324 to determine advertisements that may have been viewed by the customer. As such, GPS data may provide an indication as to the road, location, and the like that the customer is on. In this way, it is possible that one or more billboards on that road or in that location may have been viewed by the customer during his/her traveling. As such, these advertisements may be included in the advertisement impressions for the customer. Furthermore, the customer may transaction for various items during traveling, in the form of travel purchase 324. These purchases may be at train/bus stations, gas stations, airports, or the like. Based on these identified purchases, a determination of one or more advertisements that the customer may have viewed to include in his/her advertisement impressions may be made. Finally, commercials may be identified that include advertisements based on television channels and television guide systems 322. In this way, various advertisements in the form of a television commercial may be viewed by the customer, which may be included in his/her advertisement impressions.

Referring back to FIG. 5, as illustrated in block 404, the products of the viewed advertisements are retrieved by the system. In this way, the brand, type, product number, or the like is identified for the product of the transaction. As illustrated in block 406, the merchant providing the advertisements viewed are also retrieved by the system. The merchant may be the entity providing the advertisement, selling the product, or the like. The product and/or merchant may be identified and retrieved based on the advertisement itself. In some embodiments, the system may retrieve, store, and maintain information about the location of advertisements. These locations may be online, such as on a website or the like. These locations may also be offline, such as on a billboard, in a newspaper, in a magazine, or the like. In this way, the system may identify that an advertisement is being viewed by the customer, and correlate the location of the customer with the location of the advertisement to identify the advertisement being viewed. For example, the customer may be on a specific website. The system may retrieve the advertisement on that website as being viewed by the customer. The system may also have stored or receive data (from the website provider) that the advertisement that was associated with that customer's IP address, at that time, on that website location was for Product A provided by Merchant A. In some embodiments, the system could receive information that a customer viewed a billboard based on the customer's travel route. In this way, the system may know what advertisement is on which billboard on the customer's route. In this way, the system may receive an illustration, digital representation, photo, or the like of the advertisement and recognize barcodes, quick response codes (QR), names, brands, product numbers, or other identifiers on the advertisement. The system may receive the advertisement via online searching or reviewing of the webpage a customer is viewing, receiving offline advertisements, or the like. Furthermore, the advertisement viewed information may include data about the time and date the advertisement was viewed, the channel of viewing, the duration of viewing the advertisement, and/or the number of times a customer viewed the advertisement retrieved from an advertiser or merchant.

Next, as illustrated in block 408, the process 400 continues by retrieving transaction data associated with the customer. In some embodiments, the system may receive the customer's transaction activity after an advertisement impression has been identified. The retrieval may identify one or more financial transactions of the customer that are for or associated with the products or merchants of the advertisements viewed by the customer. As such, the system may identify the time and date of the advertisement impression associated with that customer, identify the product or merchant associated with that advertisement, and subsequently retrieve transaction activity of the customer to identify purchases made for the product of the advertisement and/or purchases made at the merchant of the advertisement. The system may retrieve the transaction data based on financial institution data, merchant data, social media data, or customer provided data. This data may include the time and date of the transaction as well as the payment type used by the customer to complete the transaction. The system may be provided by a financial institution, as such, the system may be able to determine if purchases are associated with products of the advertisements based on financial institution data associated with the transaction. In some embodiments, the system may determine transaction data by receiving information from the merchant, social networks, and/or the customer.

As illustrated in block 410, the system may match transaction data associated with the customer to one or more products of the advertisements viewed by that customer. As illustrated in block 412, the system may match transaction data associated with the customer to one or more merchants associated with the advertisements viewed by that customer.

Next, as illustrated in block 414, the process 400 continues by compiling the matched data for products and merchants that match between the advertisements viewed and subsequent customer transactions. This data is compiled for effectiveness tracking for marketing or advertising campaigns. In some embodiments, the effectiveness tracking data includes influencers such as a type of payment type used for a transaction for a product of an advertisement and a time/date of most successful advertisement for a product of an advertisement provides the advertiser with payment type demographics, time/date advertisement influence data, and valuation data for the advertisement.

In some embodiments, the matched data may be reviewed to retrieve the payment type used for each of the matched transactions. As such, the system may determine payment type demographics for a product of an advertisement. In this way, the system may compile data associated with all customers that viewed the advertisement and subsequently purchased the product associated with that advertisement viewed. The system may compile the payment type used and determine payment type demographics for the advertisement. In this way, the system may be able to calculate a percentage of each payment type used for the product. In some embodiments the system may determine the most used payment type, the least used payment type, an average, or the like. The system may use the payment type information to determine payment type demographics for the product of the transaction. In this way, the demographics of customers purchasing the product may be identified based on payment type utilized.

In some embodiments, the matched data may be reviewed to retrieve time/date influence data. As such, a valuation or influence of the advertisement maybe identified based on the time and date the advertisement was viewed. As such, the correlation of time and date of advertisements to transactions may aid determining the successfulness of an advertisement based on the time and date the advertisement was presented to the customer. In this way, transactions for products associated with viewed advertisements are grouped relative to the time and date the advertisement was viewed. For example, there may be identified 100 customers that purchased a product associated with an advertisement. Of those 100, 20 may have viewed the advertisement on Day A between 8:00 am and 10:00 am and 80 may have viewed the advertisement on Day A between 6:00 pm and 10:00 pm. In this way, for each product purchases, a time and date of advertisement viewed may be correlated to that purchase. The total number of customers purchasing that product may then be matched to a time and date or general time and date range of when each of the customers viewed the advertisement associated with that product. As such, the time and date data may be utilized to identify the most effective times to advertise for that particular product. As such, an influence or valuation of the advertisement time may be determined for that particular product. As a further example of this valuation is an ice cream advertisement may have stronger influence and more value if it was ran on a television channel during a summer day as opposed to a winter night.

Finally, as illustrated in block 416, the process 400 presents advertisement effectiveness data including payment demographic data and time/date influence data to advertisers.

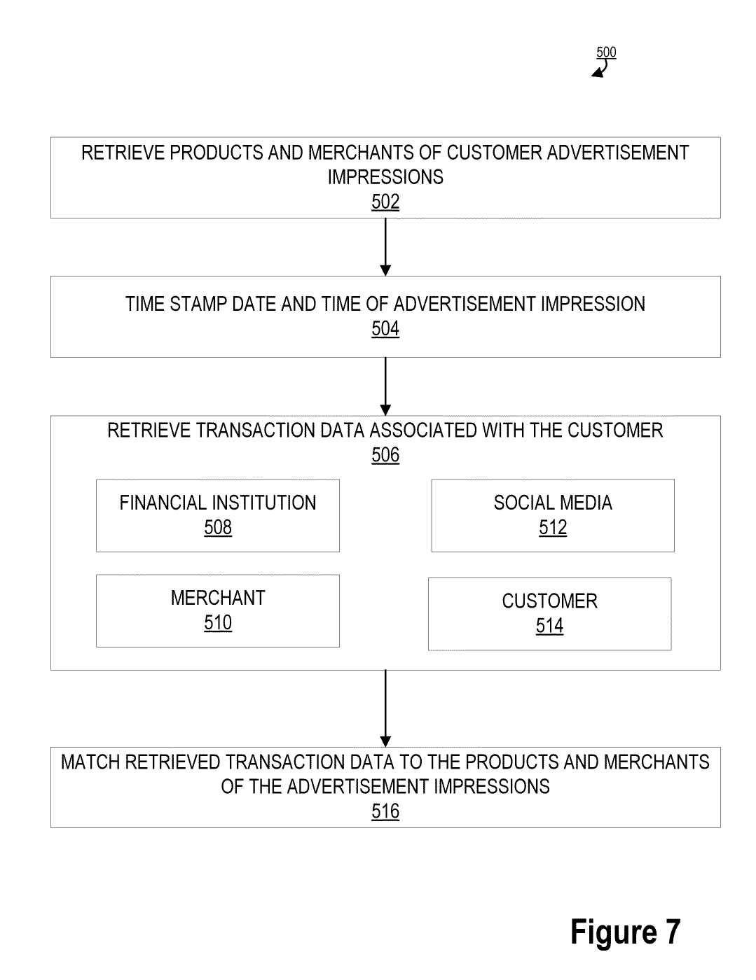

FIG. 7 illustrates a process map for transaction data retrieval and matching 500, in accordance with one embodiment of the present invention. The process 500 is initiated when products and merchants of customer advertisement impressions are retrieved, as illustrated in block 502. The system provides a time stamp on the customer's advertisement impression, as illustrated in block 504. In this way, the system may identify the date and time the customer viewed the advertisement. As such, when transaction data is reviewed for that particular advertisement, the identification of a time frame between when the advertisement was viewed and when the transaction occurred may be identified. In some embodiments, the advertisement may occur before the transaction. In some embodiments, the advertisement may occur after the transaction.

As illustrated in block 506, retrieval of transaction data associated with the customer occurs. The transaction data is retrieved and reviewed to identify one or more transactions associated with advertisements viewed by the customer. In this way, the system may identify which advertisements had a positive impact on customers, which may have not enticed a customer to purchase the products or services of the advertisement, and which advertisements may have had a negative impact. In some embodiments, the retrieved transaction data may be retrieved from the financial institution 508, social media 512, the merchant 510, or the customer 514. In some embodiments, the financial institution 508 may provide the transaction data. In this way, the system may review transaction data of the customer at the financial institution to determine if one or more transactions were completed using a financial institution account for one or more products or merchants of the viewed advertisement. With the information received at the financial institution in order to complete the transaction may allow the system to identify the merchant and/or the product of the transaction. As such, products purchased utilizing a financial institution account may be received at the financial institution and identified as at a specific merchant, associated with a particular product, or for a specific service. This information is then used to match to products or merchants that the customer viewed advertisements. Thus, this provides feedback and advertisement effectiveness data for advertisement and marketing campaigns.

Alternatively, the system may be able to retrieve transaction data from other sources associated with the transaction. In some embodiments, the merchant 510 may provide the transaction data. In this way, the merchants may provide information associated with purchases the customer has made. In some embodiments, the customer 514 may provide transaction data to the system. In this way, the customer 514 may provide the system with information regarding recent transactions that he/she has completed. Finally, the system may identify and retrieve transaction data associated with the customer based on social media 512. In this way, the system may retrieve information associated with posts or other social network endorsements that suggest a purchase or transaction being completed by the customer.

Finally, as illustrated in block 516 the process 500 is completed when the various retrieved transaction data that is associated with products or merchants a customer transacted with is then matched to products or merchants that the customer viewed advertisements from. The system may identify exact matches, such as the customer viewing an advertisement for Product A and subsequently making a purchase for Product A. Or, for example, the customer viewed an advertisement for Merchant A and subsequently completed a transaction at Merchant A. In other embodiments, the system may identify imperfect matches. These may include identifying that the customer viewed Product A related to electronics and purchased a similar electronic, Product B. In this way, there may be some value to the advertisement, or it had a negative impact on the customer such that he/she selected an alternative product.

In some embodiments, matching the transaction data to one or more products of the advertisements viewed by the customer includes determining a date and/or a date and time of a transaction completed by the customer and matching it with an advertisement viewed by the customer if the date and/or date and time of the transaction is within a selected range from the date and/or date and time when the customer viewed the advertisement. In some embodiments, matching the transaction data to products, merchants, and/or services of the advertisements viewed by the customer include identifying a time frame between when the customer viewed the at least one advertisement and the transaction of the customer associated with the merchant, product, and/or service associated with the advertisement. In some embodiments, a time frame may be identified between the advertisement being viewed and the transaction. In some embodiments, the time frame may start when the advertisement is viewed. In other embodiments, the time frame may start when the transaction has been completed. For example, if the advertisement was viewed by a customer then ten days later the customer purchased a product in the advertisement, that time frame of ten days is recorded and incorporated into the advertisement effectiveness data. In some embodiments, even if the transaction occurred before the advertisement was viewed by the customer, that data is reported and incorporated into the advertisement effectiveness data.

Furthermore, in some embodiments, the time and date that the customer viewed the advertisement may provide a valuation or influence of the advertisement. As such, the correlation of time and date of advertisements to transactions may aid determining the successfulness of an advertisement based on the time and date the advertisement was presented to the customer. In this way, transactions for products associated with viewed advertisements are grouped relative to the time and date the advertisement was viewed. As such, the time and date data may be utilized to identify the most effective times to advertise for that particular product. As such, an influence or valuation of the advertisement time may be determined for that particular product.

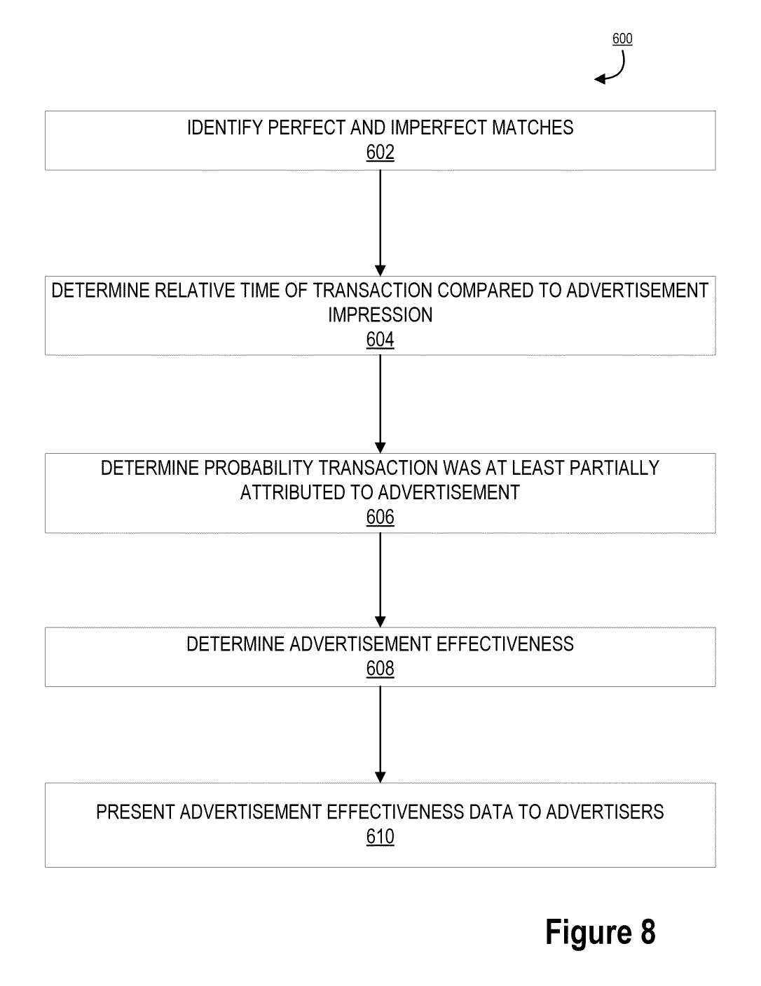

FIG. 8 illustrates a process map for creating and providing marketing effectiveness tracking data 600, in accordance with one embodiment of the present invention. As illustrated in block 602, the process 600 is initiated when perfect and imperfect matches are identified. Next, as illustrated in block 604, the process 600 continues by determining the time of the transaction compared to the time of the advertisement impression. In this way, a time frame is established from the point of viewing the advertisement to the point of the transaction. In some embodiments, a time frame is established from the point of the transaction to the point of viewing the advertisement, if the advertisement viewing came after the transaction. As such, this time frame is utilized to further calculate the effectiveness of the advertisement. In some embodiments, a short time frame indicates an effective advertisement while a longer time frame indicates a less effective advertisement. Alternatively, some advertisements, such as coupons, discounts, promotions, or the like may have time limits. As such, if a transaction isn't completed within the time limit, the advertisement was not utilized by the customer. In some embodiments, a time stamp is put on the advertisement when an advertisement is viewed by a customer. In some embodiments, a time stamp is also put on a transaction when the transaction is completed. The time range between the two time stamps is the determined time frame.

Next, as illustrated in block 606, the system may determine the probability that the transaction was at least partially attributed to the advertisement viewed. In this way, the system takes into account the likelihood that the advertisement was viewed, whether the match was perfected, and the time frame between the advertisement and the transaction in order to provide a confidence rating or probability of the advertisement success.

In some embodiments, the likelihood that the advertisement was viewed is taken into consideration by the system to predict the advertisement success. The likelihood of the advertisement was viewed is dependent on the confidence in the advertisement impression identification. The system may provide high confidence for selecting or clicking the advertisement, longer duration of viewing, social network, search results, or the like. While lower confidence, without other factors, may be applied to scrolling over the advertisement, IP address, subscriptions, GPS travel purchase, and television guides. The system may also learn, based on positive and negative results of matches, the more likely higher confidence advertisement impression identifiers as the system makes more and more matches.

In some embodiments, whether the match between the advertisement viewed and the product purchased was perfect or imperfect is taken into consideration by the system to predict the advertisement success. In some embodiments, a perfected match reflects a positive or successful advertisement. In some embodiments, an imperfect match reflects a neutral or negative advertisement. In some embodiments, the time frame between the advertisement and a transaction is taken into consideration by the system to predict the advertisement success. In some advertisements the time frame between the advertisement and transaction is critical because the advertisement is time sensitive. In other embodiments, a shorter time frame may indicate a more successful advertisement, while a longer time frame may indicate a negative advertisement. Finally, based on the likelihood that the advertisement was viewed, whether the match was perfected, and the time frame between the advertisement and the transaction a confidence score or probability that one or more transactions are associate or attributed to one or more advertisements viewed by the customer is determined.

Next, as illustrated in block 608 of FIG. 8, the process 600 continues by determining the advertisement effectiveness based on the probability. In this way, the system compiles data from multiple customers to determine an overall effectiveness of the advertisement relative to other advertisements, a base line, a goal effectiveness rating, or the like. The advertisement effectiveness may also include advertisement timing influence data and payment type demographics. The timing influence data may provide the most successful times of the advertisement for a particular product. In this way, allowing an advertiser to quantify the prime advertisement locations associated with a product or category of products. This timing influence data, along with providing feedback in the way of advertisement effectiveness data associated with advertisements may be provide to the merchant or advertiser. The payment type demographics may provide the most used payment type by customers purchasing the product of the advertisement, a percentage of each payment type used, or the like. This payment type demographics, along with providing feedback in the way of advertisement effectiveness data associated with advertisements may be provide to the merchant or advertiser.

As such, the system may also generates and provides marketing effectiveness data based on the correlation between the advertisement being viewed by the customer and a transaction for the products associated with the advertisement along with the timing influence data and payment demographics. As such, the invention generates marketing effectiveness data that tracks the advertisements and the effectiveness of the advertisements based on purchases associated with advertisement impressions.

Finally, as illustrated in block 610 the advertisers are presented with advertisement effectiveness data associated with their advertisements. The system may provide the data, probabilities, confidence scores, number of customers sampled, and the like. In this way, the system generates and provides marketing effectiveness data based on the correlation between the advertisement being viewed by the customer and a transaction for the products associated with the advertisement. As such, the invention generates marketing effectiveness data that tracks the advertisements and the effectiveness of the advertisements based on purchases associated with advertisement impressions.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for advertisement validation, the system comprising:
a memory device with non-transitory computer-readable program code stored thereon;
a communication device;
a processing device operatively coupled to the memory device and the communication device, wherein the processing device is configured to execute the computer-readable program code to:
receive information indicating one or more advertisements for a merchant, product, and/or service viewed by a customer, wherein the information indicating one or more advertisements includes a time and date the advertisement was viewed by the customer;
receive transaction data associated with transactions completed by the customer, wherein transaction data includes a payment type used to complete the transactions;
match the merchant, product, and/or service of the one or more advertisements viewed by the customer to transactions completed by the customer;
determine payment demographics for the merchant, product, and/or service, wherein the payment demographics identify the payment types used for the transaction;
determine a time influence of the advertisement, wherein the time influence of the advertisement is based on identifying the time and date of the advertisement for the merchants, product, and/or services that matched the transactions completed by the customer; and
provide advertising effectiveness data including the payment demographics and time influence data to an advertiser.

2. The system of claim 1, wherein determining payment demographics for the merchant, product, and/or service further comprises compiling the payment types used for the transactions and calculating a percentage use of each payment type for the transactions, wherein payment types include a debit account, credit account, cash, or check.

3. The system of claim 1, wherein determining the time influence of the advertisement further comprises grouping transactions together based on a specific time range of when the viewed advertisement for the merchants, product, and/or service of the transaction, wherein the groupings are compared to determine the effectiveness of the advertisement based on the time the advertisement was viewed, wherein a most effective time of the advertisement correlates to the most transactions grouped together in the specific time range.

4. The system of claim 1, wherein receiving information indicating one or more advertisements for a merchant, product, and/or service viewed by a customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer.

5. The system of claim 1, wherein receiving information indicating one or more advertisements for a merchant, product, and/or service viewed by a customer further comprises receiving information indicating a date and a time of the customer viewing of the at least one advertisement.

6. The system of claim 1, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

7. The system of claim 1, wherein providing advertising effectiveness data including the payment demographics and the time influence data further comprises providing a confidence associated with a success of the at least one advertisement based on a likelihood that the at least one advertisement was viewed by the customer, a perfect or imperfect match of products of the at least one advertisement and the transaction, and a time frame between the at least one advertisement for the product and the transaction for the product in a viewed advertisement.

8. A computer program product for advertisement validation, the computer program product comprising at least one non-transitory computer-readable medium having computer-readable program code portions embodied therein, the computer-readable program code portions comprising:
an executable portion configured for receiving information indicating one or more advertisements for a merchant, product, and/or service viewed by a customer, wherein the information indicating one or more advertisements includes a time and date the advertisement was viewed by the customer;
an executable portion configured for receiving transaction data associated with transactions completed by the customer, wherein transaction data includes a payment type used to complete the transactions;
an executable portion configured for matching the merchant, product, and/or service of the one or more advertisements viewed by the customer to transactions completed by the customer;
an executable portion configured for determining payment demographics for the merchant, product, and/or service, wherein the payment demographics identify the payment types used for the transaction;
an executable portion configured for determining a time influence of the advertisement, wherein the time influence of the advertisement is based on identifying the time and date of the advertisement for the merchants, product, and/or services that matched the transactions completed by the customer; and
an executable portion configured for providing advertising effectiveness data including the payment demographics and time influence data to an advertiser.

9. The computer program product of claim 8, wherein determining payment demographics for the merchant, product, and/or service further comprises compiling the payment types used for the transactions and calculating a percentage use of each payment type for the transactions, wherein payment types include a debit account, credit account, cash, or check.

10. The computer program product of claim 8, wherein determining the time influence of the advertisement further comprises grouping transactions together based on a specific time range of when the viewed advertisement for the merchants, product, and/or service of the transaction, wherein the groupings are compared to determine the effectiveness of the advertisement based on the time the advertisement was viewed, wherein a most effective time of the advertisement correlates to the most transactions grouped together in the specific time range.

11. The computer program product of claim 8, wherein receiving information indicating one or more advertisements for a merchant, product, and/or service viewed by a customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer.

12. The computer program product of claim 8, wherein receiving information indicating one or more advertisements for a merchant, product, and/or service viewed by a customer further comprises receiving information indicating a date and a time of the customer viewing of the at least one advertisement.

13. The computer program product of claim 8, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

14. The computer program product of claim 8, wherein providing advertising effectiveness data including the payment demographics and the time influence data further comprises providing a confidence associated with a success of the at least one advertisement based on a likelihood that the at least one advertisement was viewed by the customer, a perfect or imperfect match of products of the at least one advertisement and the transaction, and a time frame between the at least one advertisement for the product and the transaction for the product in a viewed advertisement.

15. A computer-implemented method for advertisement validation, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving information indicating one or more advertisements for a merchant, product, and/or service viewed by a customer, wherein the information indicating one or more advertisements includes a time and date the advertisement was viewed by the customer;
receiving transaction data associated with transactions completed by the customer, wherein transaction data includes a payment type used to complete the transactions;
matching the merchant, product, and/or service of the one or more advertisements viewed by the customer to transactions completed by the customer;
determining payment demographics for the merchant, product, and/or service, wherein the payment demographics identify the payment types used for the transaction;
determining a time influence of the advertisement, wherein the time influence of the advertisement is based on identifying the time and date of the advertisement for the merchants, product, and/or services that matched the transactions completed by the customer; and
providing advertising effectiveness data including the payment demographics and time influence data to an advertiser.

16. The computer-implemented method of claim 15, wherein determining payment demographics for the merchant, product, and/or service further comprises compiling the payment types used for the transactions and calculating a percentage use of each payment type for the transactions, wherein payment types include a debit account, credit account, cash, or check.

17. The computer-implemented method of claim 15, wherein determining the time influence of the advertisement further comprises grouping transactions together based on a specific time range of when the viewed advertisement for the merchants, product, and/or service of the transaction, wherein the groupings are compared to determine the effectiveness of the advertisement based on the time the advertisement was viewed, wherein a most effective time of the advertisement correlates to the most transactions grouped together in the specific time range.

18. The computer-implemented method of claim 15, wherein receiving information indicating one or more advertisements for a merchant, product, and/or service viewed by a customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer.

19. The computer-implemented method of claim 15, wherein receiving information indicating one or more advertisements for a merchant, product, and/or service viewed by a customer further comprises receiving information indicating a date and a time of the customer viewing of the at least one advertisement.

20. The computer-implemented method of claim 15, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.
